(19) United States
(12) Patent Application Publication
(10) Pub. No.: US 2005/0155785 A1
(43) Pub. Date: Jul. 21, 2005

(54) Method of producing a sheath for a multifilament superconducting cable and sheath thus produced

(76) Inventors: Franz Hauner, Rottenbach (DE); William Andrew Robertson Ferrier, Worcestershire (GB)

Correspondence Address: VAN TASSEL AND ASSOCIATES, POST OFFICE BOX 2928, BELLAIRE, TX, 77402-2928, US

(21) Appl. No.: 10/508,896

(22) PCT Filed: Mar. 3, 2003
(86) PCT No.: PCT/CH03/00149

(30) Foreign Application Priority Data
Mar. 21, 2002 (EP) 02405215.1

(51) Int. Cl. H01B 12/00

(52) U.S. Cl. 174/125.1

(57) ABSTRACT

The invention relates to a method of producing a sheath for a high-temperature multifilament superconducting cable. According to the invention, the sheath is obtained through the co-extrusion of a cylindrical billet (50) comprising at least two concentric cylinders (52, 54, 56). The invention also relates to a sheath for a high-temperature multifilament superconducting cable which is produced using the aforementioned method. The inventive sheath consists of a tube (10) with a multi-layer wall comprising: a pure silver inner layer (12, 16, 22) and at least one second silver-based alloy layer (14, 18, 24, 26).

The present invention relates to superconducting cables and tapes used at liquid nitrogen temperature (−196° C.) and called “high temperature” superconducting cables and tapes so as to distinguish them from those operating at temperatures close to −273° C.

To make it easier to read this document, it is understood that the word “cable” will be used to denote both cables themselves and tapes formed by flattening these cables.

More particularly, the invention relates, on the one hand, to a process for manufacturing a sheath serving as matrix for the high-temperature superconducting fibers of a multifilament cable and, on the other hand, to a sheath obtained using this process.

Superconducting cables of the above type generally consist of a bundle of wires made of superconducting material that are placed inside a matrix, which isolates them from one another and from the outside.

The superconducting material is typically an oxide such as those called BSCCO 2223 and 2212, and other examples of which are provided, for example, in patent U.S. Pat. No. 6,188,921.

More precisely, each superconducting wire is contained in a sheath made of a compatible material which is brought to its final dimension, about 1.5 mm, by drawing. This wire is then combined with other identical wires into a bundle inside an external sheath which is, in turn, drawn down to a diameter of about 1.55 mm in order to form a cable or, after rolling, a multifilament tape.

The matrix that the sheaths form is generally made of metal. Silver and its alloys constitute a material preferred by experts in the field, as it is ductile, does not contaminate the superconducting wire and is relatively transparent to oxygen.

Unfortunately, silver has drawbacks. This is because when it is pure its properties, on the one hand, do not allow it to reinforce the superconductor against high electromagnetic stresses in high fields, and on the other hand, do not protect the wire from fracture. In addition, its high electrical conductivity favors high ohmic losses for AC applications (transverse losses).

To alleviate the mechanical weakness of silver, it is common practice to use more robust alloys, especially the alloy AgMgNi which hardens by internal oxidation, well known in the field. However, this alloy is, in turn, not free of drawbacks since the nickel that it contains is a poison for the superconducting material, and the oxidized magnesium prevents the fibers from being bonded together during manufacture of the multifilaments.

To alleviate the high electrical conductivity of silver, resistive alloys are used, especially the alloy AgAu which itself is not without drawback either. This is because under certain conditions, gold affects the properties of the superconductor.

To employ these combinations of alloys, patent U.S. Pat. No. 5,017,553, for example, describes a process for producing a sheath for a superconducting wire, in which sheath two layers, one made of an Ag/Pd alloy and the other made of silver, are superposed. According to the process, the layers constitute independent tubes that are slipped one into the other, the superconducting ceramic then being placed inside this construction.

This kind of technique has several drawbacks. Firstly, it is difficult to superpose several thin tubes of different materials and, for a complex structure with many tubes, the number of operations to be carried out is large. Moreover, the techniques used mean that each of the tubes used has to be available beforehand. Now, since silver has a poor mechanical strength, it is difficult to handle thin silver tubes and therefore to obtain a sheath with a thin silver layer.

The object of the present invention is to provide a technology free of the abovementioned drawbacks, while still benefiting from the advantages offered by the processes of the prior art.

More precisely, the invention relates to a process for manufacturing a sheath for a high-temperature superconducting cable, characterized in that it consists of a tube whose multilayer wall comprises, these being diffusion-bonded together:

an inner layer of pure silver; and

at least one second layer of a silver-based alloy.

The wall may be formed from two, three or four layers.

Advantageously, the silver-based alloys used are an alloy of high mechanical strength, an alloy of high electrical resistance or an alloy of high mechanical strength and high electrical resistance.

The invention also relates to a process for manufacturing a sheath for a high-temperature superconducting cable. It is characterized in that the multilayer-walled tube is obtained by coextrusion of a cylindrical billet formed from at least two concentric cylinders. The billet is produced by forming, inside a container, by cold isotactic pressing, at least two tubes made of powder consisting of the desired materials respectively, and then subjecting these tubes to a sintering operation.

Other features of the invention will emerge from the description that follows, given with regard to the appended drawing, in which:

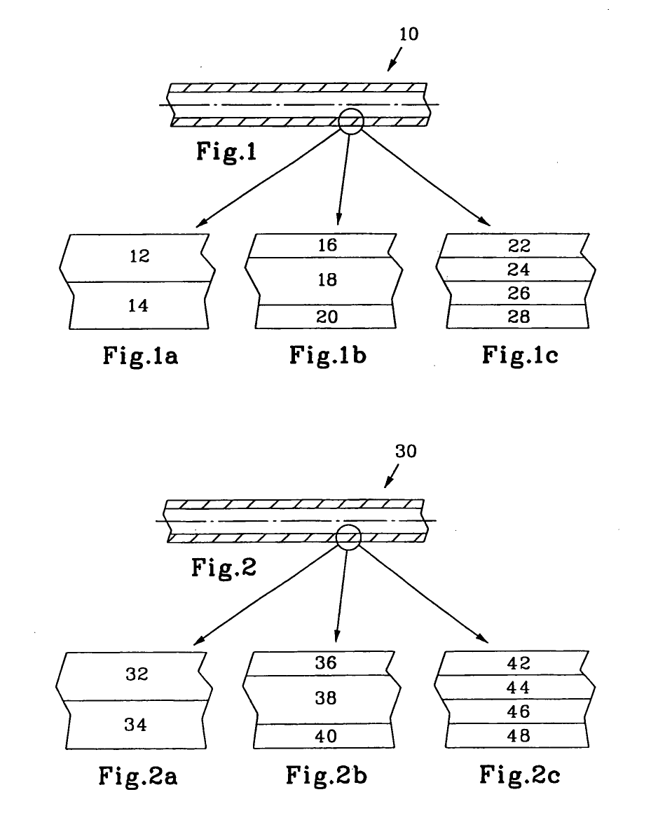

FIGS. 1, 1a, 1b and 1c show a tube for an internal sheath;

FIGS. 2, 2a, 2b and 2c show a tube for an external sheath; and

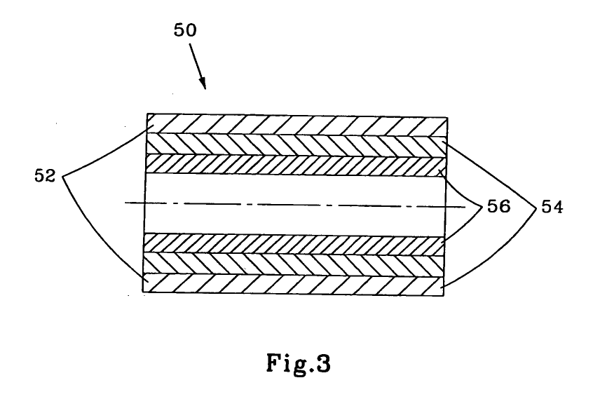

FIG. 3 shows the billet used to obtain these tubes.

FIG. 1 shows, at 10, a tube intended to form a sheath of a superconducting wire, called an internal sheath. Typically, this tube has an outside diameter of 20 mm and inside diameter of 17 mm. Its length may range from 1 to 3 m. Such a tube, once filled with superconducting material, is intended to be drawn down to a diameter of about 1.5 mm. It will then be combined with other identical wires into a bundle inside an external sheath in order to form a superconducting bundle which will, in turn, be drawn down to a diameter of about 1.5 mm, in order to form a cable or, after rolling, a multifilament tape. The multiple sheathing process may optionally be carried out in several steps by making use of at least one intermediate sheath. In this case, the structure of the intermediate sheath is the same as that of the internal sheath.

According to the invention, the wall of the tube 10 may be formed from two, three or four silver-based layers, as shown on an enlarged scale in FIGS. 1a, 1b and 1c respectively.

Four different materials are used for making up the layers, namely:

pure silver;

silver of high mechanical strength, called hard silver, which may, for example, be one of the following alloys; AgMgNi (99.55-0.25-0.20) and AgMn (99-1);

silver of high electrical resistance, called resistive silver, which may, for example, be one of the following alloys: AgAu (96-4) and AgSb (99-1); and

silver of high mechanical and electrical strength, called hard-resistive silver, which may, for example, be AgAuMgNi (95.55-4-0.25-0.20).

In the two-layer embodiment of FIG. 1a, the inner layer 12 is of pure silver and the outer layer 14 is of resistive silver.

In the three-layer embodiment of FIG. 1b, the inner layer 16 is of pure silver, the intermediate layer 18 is of hard silver or hard-resistive silver and the outer layer 20 is of pure silver. As a variant, the inner layer 16 is of pure silver, the intermediate layer 18 is of hard silver and the outer layer 20 is of resistive silver.

Finally, in the four-layer embodiment of FIG. 1c, the inner layer 22 is of pure silver, the first intermediate layer 24 is of hard silver, the second intermediate layer 26 is of resistive silver and the outer layer 28 is of pure silver. As a variant, the first intermediate layer 24 is of resistive silver and the second intermediate layer 26 is of hard silver.

Referring now to FIG. 2, this shows at 30 a tube intended to form the abovementioned external sheath of a superconducting cable. The tube 30 is not distinguished, by its dimensions, from the undrawn tube 10 that has just been described. Like it, its wall may be formed from two, three or four silver-based layers, as shown on an enlarged scale in FIGS. 2a, 2b and 2c respectively. The constituent materials are the same, but the organization of the various layers is different.

In the two-layer embodiment of FIG. 2a, the inner layer 32 is of pure silver and the outer layer 34 is of hard silver or hard-resistive silver.

In the three-layer embodiment of FIG. 2b, the inner layer 36 is of pure silver, the intermediate layer 38 is of hard silver or hard-resistive silver and the outer layer 40 is of silver. In a first variant, the inner layer 36 is of pure silver, the intermediate layer 38 is of hard silver and the outer layer 40 is of resistive silver. In a second variant, the inner layer 36 is of pure silver, the intermediate layer 38 is of resistive silver and the outer layer 40 is of hard silver.

Finally, in the four-layer embodiment of FIG. 2c, the inner layer 42 is of pure silver, the first intermediate layer 44 is of hard silver, the second intermediate layer 46 is of resistive silver and the outer layer 48 is of pure silver. As a variant, the first intermediate layer 44 is of resistive silver and the second intermediate layer 46 is of hard silver.

Whether the tubes are for internal sheaths or external sheaths, the relative proportions by volume of the various layers are the following:

two-layer structure:
inner layer: 10 to 90%
outer layer: 90 to 10%;

three-layer structure:
inner and outer layers: 10 to 40%
intermediate layer: 80 to 20%; and

four-layer structure:
inner and outer layers: 10 to 40%
intermediate layers: 70 to 10%.

Thus, a tube for an internal or intermediate sheath and a tube for an external sheath are produced, which, thanks to their multilayer structure, take advantage of the properties of pure silver and of some its alloys (which are harder or more resistive), while masking their undesirable effects. These sheaths allow superconducting tapes of excellent quality to be produced.

In particular, it should be noted that the proposed structure makes it possible, especially thanks to the presence of a layer of silver alloy having a high resistivity, to substantially reduce the ohmic losses in AC applications. Moreover, for the tubes using an oxidation-hardened alloy, such as AgMgNi, AgAuMgNi or AgMn, an outer sheathing with a nonoxidizable metal, such as AgAu or pure Ag, prevents the Mg or Mn from oxidizing during the first manufacturing phases by protecting it from the ambient atmosphere and makes it possible to greatly limit the wear of the dies used.

The multilayer tubes according to the invention are advantageously obtained by coextruding a cylindrical billet 50, as shown in FIG. 3 in the case of a three-layer structure, which is then formed from three concentric cylinders 52, 54 and 56. Typically, this billet has an outside diameter of about 120 mm.

The billet 50 may be prepared either by assembling three metal tubes, of appropriate outside and inside diameters, made of the desired materials respectively, or by forming, inside a container, by cold isostatic pressing, three tubes made of powder of these materials and then by subjecting the whole assembly to a sintering operation, typically at a temperature of 850° C., involving a diffusion-bonding of the tubes.

To simplify the assembly operation, the internal tube may optionally be replaced with a solid cylinder, which is revealed subsequently.

The billet 50 is then extruded using any process known to those skilled in the art so as finally to obtain the tube 10 or 30, the outside diameter of which is reduced by a factor of 2 to 10 compared with the initial diameter of the billet. The extrusion step involves, for the case in which the billet has not been sintered, a diffusion-bonding over a few atomic thicknesses of the layers that form the tube.

1. A process for manufacturing a sheath for a high-temperature multifilament superconducting cable, characterized in that said sheath is obtained by coextrusion of a cylindrical billet (50) formed from at least two concentric cylinders (52, 54, 56), said billet (50) being produced by forming, inside a container, by cold isostatic pressing, at least two tubes made of powder consisting of the desired materials respectively, and then subjecting these tubes to a sintering operation.

2. A sheath for a high-temperature multifilament superconducting cable, characterized in that it consists of a tube (10, 30) whose wall comprises, these being diffusion-bonded together:
an inner layer of pure silver; and
at least one second layer of silver-based alloy.

3. The sheath for a multifilament superconducting cable as claimed in claim 2, characterized in that the wall of the tube is formed from at least two layers, these being diffusion-bonded together, i.e.:
an inner layer (12) of pure silver; and
an outer layer (14) of a silver alloy of high electrical resistance.

4. The sheath for a multifilament superconducting cable as claimed in claim 2, characterized in that the wall of the tube is formed from three layers, these being diffusion-bonded together, i.e.:
an inner layer (16) of pure silver;
an intermediate layer (18) of a silver alloy of high mechanical strength; and
an outer layer (20) of pure silver.

5. The sheath for a multifilament superconducting cable as claimed in claim 2, characterized in that the wall of the tube is formed from three layers, these being diffusion-bonded together, i.e.
an inner layer (16) of pure silver;
an intermediate layer (18) of a silver alloy of high mechanical strength and high electrical resistance; and
an outer layer (20) of pure silver.

6. The sheath for a multifilament superconducting cable as claimed in claim 2, characterized in that the wall of the tube is formed from three layers, these being diffusion-bonded together, i.e.:
an inner layer (16) of pure silver;
an intermediate layer (18) of a silver alloy of high mechanical strength; and
an outer layer (20) of silver of high electrical resistance.

7. The sheath for a multifilament super conducting cable as claimed in claim 2, characterized in that the wall of the tube is formed from four layers, these being diffusion-bonded together, i.e.:
an inner layer (22) of pure silver;
a first intermediate layer (24) of a silver alloy of high mechanical strength;
a second intermediate layer (26) of a silver alloy of high electrical resistance; and
an outer layer (28) of pure silver.

8. The sheath for a multifilament superconducting cable as claimed in claim 2, characterized in that the wall of the tube is formed from four layers, these being diffusion-bonded together, i.e.:
an inner layer (22) of pure silver;
a first intermediate layer (24) of a silver alloy of high electrical resistance;
a second intermediate layer (26) of a silver alloy of high mechanical strength; and
an outer layer (28) of pure silver.

9. The sheath for a multifilament superconducting cable as claimed in claim 2, characterized in that the wall of the tube is formed from two layers, these being diffusion-bonded together, i.e.:
an inner layer (32) of pure silver; and
an outer layer (34) of a silver alloy of high mechanical strength.

10. The sheath for a multifilament superconducting cable as claimed in claim 2, characterized in that the wall of the tube is formed from two layers, these being diffusion-bonded together, i.e.:
an inner layer (32) of pure silver; and
an outer layer (34) of a silver alloy of high mechanical strength and high electrical resistance.

11. The sheath for a multifilament superconducting cable as claimed in claim 2, characterized in that the wall of the tube is formed from three layers, these being diffusion-bonded together, i.e.:
an inner layer (36) of pure silver;
an intermediate layer (38) of a silver alloy of high electrical resistance; and
an outer layer (40) of a silver alloy of high mechanical strength.
